(19) United States
(12) Patent Application Publication
(10) Pub. No.: US 2026/0350077 A1
(43) Pub. Date: Nov. 5, 2026

(54) SYSTEMS AND METHODS FOR HIGH-SPEED INFERENCE

(71) Applicant: High Functioning Corporation, Needham, MA (US)

(72) Inventor: Morgan Rockett, Needham, MA (US)

(21) Appl. No.: 19/531,294

(22) Filed: Feb. 5, 2026

Related U.S. Application Data
(60) Provisional application No. 63/798,897, filed on May 2, 2025.

(51) Int. Cl. G06F 16/34

(52) U.S. Cl. CPC G06F 16/345

(57) ABSTRACT

The present invention discloses various systems and methods to quickly summarize large amounts of text using a large language model. In particular, the invention allows for the summarization of text that may comprise unlimited context windows in seconds. This speed and versatility are achieved through the selective chunking, parallel processing, and AI optimized hardware taught herein.

### BACKGROUND

There is interest and value in quickly generating summaries for large bodies of text. Various techniques have been developed for generating such summaries. For example, the development of large language models (LLMs) and other types of machine learning models has made it possible to summarize text quickly via user-generated prompts. A user simply has to create a prompt that directs the model to summarize an input. However, the size constraints of existing models can limit the quantity of information that can be provided to an LLM for summary. As a result, it may be difficult to provide the entirety of a text to be summarized within a single input.

One solution may be to increase the context window of existing LLMs. However, equipping a model with a large context window comes with several drawbacks. For example, computing requirements scale quadratically with the length of an input. If the number of input tokens doubles, the model may need up to 4 times as much processing power to handle it. Increased processing power also means increased costs to maintain and use the servers hosting the LLMs. Similarly, increasing the context window may also slow down outputs. Each time the model autoregressively predicts the next token in a sequence, it computes the relationships between that token and every single preceding token in the sequence. So, inference might be fast at the beginning of an input but become slower as the length of the input increases. These slow speeds can be an issue for use cases requiring near-instantaneous inference in real-time.

Additionally, most LLM providers restrict the context windows for their application programming interfaces (APIs) beyond the LLM's intrinsic limits. So even if an LLM could theoretically handle a larger context window, a user may not be able to take full advantage of the increased size. It may also not be practical for a user to run an LLM on personal hardware just to avoid API bottlenecks. Edge devices (non-data centers like laptops and phones) have significantly less memory and may not have the appropriate processors to handle large inputs. Processors that can handle large inputs may be too expensive to be practical for an individual user.

Accordingly, there is a need for an accessible method to quickly summarize large bodies of text.

### SUMMARY

The invention provides systems and methods for high-speed summarization of texts that exceed the context windows of current LLMs and APIs. The invention achieves these speeds and overcomes the restrictions of context windows through selective chunking methods. For example, after a body of text is split into chunks that, along with a prompt, may fit the context window of an LLM or API, certain chunks may be selected to send to the LLM for summary. In other words, certain chunks, but not others, may be used to inform a final summary of the text.

The chunks may be selected using a set of rules. The rules may consist of applying an algorithm, such as the square root or natural log, to the total number of chunks created from the original text. The chunks selected according to the set of rules may be a first subset of chunks that may be sent to the LLM, where the LLM may then send back summaries of each chunk. The returned summaries may then be combined and sent back to the LLM once more to receive a single, final summary.

However, if the size of the combined summaries is still larger than the context window, then the method may be repeated with the combined summary. The combined summary may be chunked using the same set of rules from the first subset to create a second subset of chunks. The second subset of chunks may once again be sent to the LLM with a prompt to return summaries of each of the chunks. Upon return, the summaries of the second subset may be combined and sent back to the LLM for a final summary or chunked and summarized again. This selective chunking method may be repeated as many times as needed until the summaries received from the LLM may be combined and sent back to the LLM without needing to be chunked.

The body of text may also be tokenized prior to selective chunking. Here, the natural human language of the text may be converted to numbers or “tokens” that an LLM can understand. The number of tokens that, on average, may be needed per word depends on the language of the dataset, but generally about 3-4 characters of a word may equal 1 token. The tokenized text may be split into chunks and the selective chunking process may be performed on the tokenized chunks, such that the LLM is receiving chunks consisting of tokens instead of the original, natural language of the text. The LLM may then return tokenized summaries. Methods of the invention may continue to operate using summaries and chunks that are tokenized until the final summary is generated, which may then be converted back to the natural human language of the original text.

In certain aspects, the invention provides a method for summarizing text where the body of the text is split into chunks. The chunks may be then selected according to a set of rules to create a first subset of chunks. Each chunk of the first subset may then be input into a large language model accompanied by a prompt for the LLM to give a summary of the chunk. The LLM may return a summary of each chunk that is sent from the first subset. A second subset may then be selected according to the set of rules used in the first subset and then sent to the LLM with a prompt for a summary of the second subset, receiving a second-summary subset from the LLM. The second-summary subset may be provided as the penultimate set of summaries to the LLM. Alternatively, additional subsets may be selected by the same set of rules used to select the previous subsets to receive a subsequent tier of summaries. The subsequent summaries may be provided as the penultimate set of summaries to the LLM, and the returned penultimate set of summaries may be combined into a summary of the text.

Methods of the invention may use a set of rules that specify different subsets or sizes of subsets at different stages of the method. The set of rules may also provide that the chunks created from splitting the text are a number N, and the first subset of the chunks may include a number f(N) of chunks, where f(N)=ln(N) or root(N). The first subset of chunks may also be chosen by taking the Log2 or square root of a number of the plurality of chunks. The chunks not chosen by the set of rules may not be included in the first subset and thus may not be presented to the LLM or inform the summary of the text. The set of rules may also specify that the first subset and the second subset are respective first and second tiers of an iterative summarization operation, where at each tier of the iterative summarization operation, a tier-specific number of chunks may be selected for summary. At the first tier of the iterative summarization operation, a first batch of the plurality of chunks may be combined into a first batch summary and a second batch of the plurality of chunks may be combined into a second batch summary, so that the first set of summaries may include the first batch summary and the second batch summary.

In some aspects, the LLM may provide the first set of summaries, the second-summary subset, and the subsequent tier of summaries as part of a tiered operation defined by the set of rules, where a specific subset may be selected independently at each tier. The LLM may also summarize each chunk of the plurality of chunks in an independent process and execute multiple processes in parallel.

The invention may include tokenizing the text so that each chunk of the plurality of chunks is a number of tokens. After initiation of the tokenizing step, a summary of the text may be provided in less than 1 minute if the body of text is at least 32,000 pages of English language writing and the number of tokens is greater than 3 million. The body of text may be a collection of documents from a legal proceeding, a bill drafted by a legislature, a corpus of literary work, a corpus of research and/or publications relating to one company or stock trading symbol, the results of a document production request, a corpus of text comprising multiple gigabytes of text, or a set of material returned by a search of a database or the Internet.

Methods and systems of the invention may have the splitting and combining steps performed on a client computer system, where the text may then be sent to, and received from, a server system hosting the LLM via an API specific to the LLM. The splitting step may ensure that each chunk, plus a prompt, fits within a context window of the LLM. In some cases, once each chunk and prompt fit within a context window of the LLM, the LLM may give a summary of that chunk within about 1 second of receiving that chunk. The LLM may operate within an AI accelerator on a remote system communicatively coupled to the client system executing the splitting through combining steps of the method. The client system may be a laptop or desktop computer. The recited steps may be executed by computer program instructions residing on a client computer used by a user. The prompt and the prompt for the summary of the second subset may each be independently entered by the user or pre-stored among the computer program instructions.

Other aspects of the invention include splitting the text based on chapter breaks, section headers, or other markers within the text. The chunks for the first subset may be selected based at least in part on being near or including the beginning of a section or chapter of the text. The chunks may be prepared using a retrieval augmented generation (RAG) operation or an operation may be performed to replace one or more pronouns in the text with antecedents.

Related aspects provide a system for summarizing text. The system may comprise a processor coupled to a memory that has instructions stored therein that may be executable by the processor. The instructions may cause the system to split a body of text into a plurality of chunks, select, according to a set of rules, a first subset of the chunks and input each chunk of the first subset into a large-language model (LLM) in parallel with a prompt for the LLM to give a summary of that chunk. The LLM may return a first set of summaries that may include one summary for each chunk of the first subset. A second subset, selected according to the set of rules from the first set of summaries, may be sent to the LLM with a prompt for a summary of the second subset. A second-summary subset from the LLM may be received, and the second-summary subset may be provided as a penultimate set of summaries to the LLM. Alternatively, additional subsets selected by the set of rules may be sent to the LLM to receive a subsequent tier of summaries, which may then be provided as the penultimate set of summaries. The penultimate set of summaries may be combined into a summary of the text.

In some embodiments, the set of rules may specify different subsets or sizes of subsets at different stages. In other embodiments, the plurality of chunks may comprise a number N of chunks, and the set of rules may provide that the first subset of the chunks may include a number f(N) of chunks, wherein f(N)=ln(N) or root(N). The first subset and the second subset may comprise respective first and second tiers of an iterative summarization operation, wherein the set of rules may provide that, at each tier of the iterative summarization operation, a tier-specific number of chunks may be selected for summary. In some embodiments, the set of rules may provide that the first subset of chunks comprises the Log2 or square root of a number of the plurality of chunks. Chunks that are not included in the first subset may not be presented to the LLM and thus may not inform the summary of the text. In some embodiments, the LLM may provide the first set of summaries, the second-summary subset, and the subsequent tier of summaries as part of a tiered operation defined by the set of rules. The tiered operation may select a specific subset independently at each tier. In other embodiments, at the first tier of the iterative summarization operation, a first batch of the plurality of chunks may be combined into a first batch summary and a second batch of the plurality of chunks may be combined into a second batch summary, wherein the first set of summaries may comprise the first batch summary and the second batch summary.

In some embodiments, the splitting and combining steps may be provided on a client computer system and the text may be sent to, and received from, a server system hosting the LLM via an application programming interface (API) specific to the LLM. The splitting step may provide that one chunk of the plurality of chunks plus the prompt fits within a context window of the LLM. The LLM may summarize each chunk of the plurality of chunks in an independent process and execute multiple processes in parallel. The system may tokenize the text whereby each chunk of the plurality of chunks comprises a number of tokens. When the body of text comprises at least 32,000 pages of English language writing and when the number of tokens may be greater than 3 million, the summary of the text may be provided in under 1 minute after initiation of a tokenizing step. In some embodiments, the body of text comprises one selected from the group consisting of: a collection of documents from a legal proceeding, a bill drafted by a legislature, a corpus of literary work, a corpus of research and/or publications relating to one company or stock trading symbol, the results of a document production request, a corpus of text comprising multiple gigabytes of text, and a set of material returned by a search of a database or the Internet. In some embodiments, each chunk and the prompt may fit within a context window of the LLM, wherein the LLM gives the summary of that chunk within about 1 second of receiving that chunk, and wherein the LLM operates within an AI accelerator on a remote system communicatively coupled to a client system executing the splitting through combining steps of the method, wherein the client system comprises a laptop or desktop computer.

### BRIEF DESCRIPTION OF THE DRAWINGS

FIG. 1 shows a method for summarizing text that is larger than a context window.

FIG. 2 shows a simplified method to summarize text that is larger than a context window.

FIG. 3 shows a method implemented in iterative tiers to generate more than one combined summary.

FIG. 4 illustrates how methods and systems of the invention may use log2 chunking to determine how many and which chunks should be sent to the LLM for summary.

FIG. 5 shows how the log2 selected chunks may be used by systems and methods of the invention.

FIG. 6 illustrates how methods and systems of the invention may use square root chunking to determine how many and which chunks should be sent to the LLM for summary.

FIG. 7 shows how the square root selected chunks may be used by systems and methods of the invention.

### DETAILED DESCRIPTION

The invention discloses ways to quickly summarize bodies of text that exceed the bounds of context windows within a large language model (LLM) or application programming interface (API).

A large language model is a type of machine learning model designed for natural language processing tasks such as language generation or summarization. LLMs may be language models with many parameters and may be trained with self-supervised learning on a vast amount of text. Certain LLMs may be generative pretrained transformers (GPTs). GPTs are artificial neural networks that may be used in natural language processing by machines. GPTs are based on transformer deep learning architecture, pre-trained on large data sets of unlabeled text, and are able to generate novel human-like content.

The LLM may operate within a processing unit that may be housed on a remote system that may be communicatively coupled to a client system, which is discussed in more detail below. Processing units may be graphics processing units (GPUs), tensor processing units (TPUs), language processing units (LPUs), and wafer-scale engines (WSEs). The processor may be an AI accelerator or an application-specific integrated circuit (ASIC) that may be created specifically for accelerating and handling the workloads of LLMs. An application-specific integrated circuit is an integrated circuit chip customized for a particular use rather than for general-purpose use, such as a chip designed to run in a digital voice recorder or a high-efficiency video codec.

ASICs may include entire microprocessors, memory blocks including ROM, RAM, EEPROM, flash memory, and other large building blocks on a single chip. TPUs and LPUs are particularly notable ASICs. For example, TPUs are optimized for the high-volume, high-speed tensor processing required in deep learning applications. LPUs are designed specifically for handling natural language processing (NLP) tasks. LPUs are optimized for sequential processing, which is useful for understanding and generating human language. Wafer-scale engines, similar to TPUs, are optimized for network training and inference for deep learning. Examples of processing units that may be used with systems and methods of the invention may be the NVIDIA H200, Groq LPU, Amazon Trainium, and Cerebras WSE-3, among others.

Many LLMs can be fine-tuned for specific tasks or guided by prompt engineering. These models acquire predictive power regarding syntax, semantics, and ontologies inherent in human language corpora. Examples of LLMs that may be used with systems and methods of the invention include Google Gemini, Meta Llama, OpenAI gpt-4.5, and o3, among others.

One purpose that LLMs serve, and which is improved upon in the present invention, is the summarization of a body of text. A body of text may be a collection of documents from a legal proceeding, a bill drafted by a legislature, a corpus of literary work, a corpus of research and/or publications relating to one company or stock trading symbol, the results of a document production request, a corpus of text comprising multiple gigabytes of text, or a set of material returned by a search of a database or the Internet. The aim of text summarization is to condense large amounts of complex information into a shorter, more understandable version, enabling users to review more materials in less time and make more informed decisions. The systems and methods of the invention improve on current LLM summarization practices by overcoming the size and speed limitations imposed by the context windows of LLMs and their associated APIs.

An application programming interface (API) is a connection between computers or between computer programs. It is a type of software interface offering a service to other pieces of software. With large language models, application programming interfaces may act as translators, allowing seamless exchange between LLMs and artificial intelligence (AI) applications. These interfaces facilitate the integration of natural language processing (NLP) and natural language understanding capabilities into software systems.

LLM APIs are based on a request-response architecture that follows a series of steps. First, an application, operated by a user, sends a request—generally in the form of a hypertext transfer protocol (HTTP) request—to the API. Before transmission, the application first converts the request into the API's required data format (usually in JavaScript Object Notation or JSON), which contains information such as the model variant, the actual prompt and other parameters. After the API receives a request, the API forwards the request to the LLM for processing. The machine learning model draws upon its NLP skills—be it content generation, question answering, sentiment analysis, text generation or text summarization—to produce a response that is relayed to the API. Finally, the API delivers this response back to the application for the user to see.

Applications or computer programs related to the invention may be accessed on a client system operated by a user. The client system may be a phone, laptop, or desktop computer. Applications on the client system may connect through an API to select a hosted LLM such as Llama, Gemini, DeepSeek, MiniMax, or Qwen Turbo, among others. An API may be accessed through API providers such as Cerebras, Groq, and SambaNova, among others. Using the client system and the applications or programs on the client system, a user may input a prompt instructing the LLM to summarize an accompanying text. A prompt describes the task that an artificial intelligence (AI) program like an LLM should perform. A prompt for a language model may be a query, a command, or a longer statement including context, instructions, and conversation history. The prompt and text that is input by a user may be in a natural language or may be tokenized prior to input. If the user does not tokenize the text first, then the API may tokenize the text.

Tokenization is a process that breaks down an input into smaller pieces, or tokens. These tokens may be associated with unique integer IDs according to the vocabulary the LLM was trained on. The tokens may then be converted into embeddings that give the tokens semantic meaning that the LLM can understand. The number of tokens that, on average, may be needed per word depends on the language of the dataset. For example, a token can stand in for a single character, a part of a word (such as a suffix or prefix), a whole word or even a short multiword phrase. Different models or tokenizers might tokenize the same passage of writing differently. For general purposes, an estimate may be roughly 1 token per small or average-sized English word. For example, when the body of text comprise at least 32,000 pages of English language writing, the number of tokens may be greater than 3 million. Using the systems and methods described herein, the summary of the text may be provided in under 1 minute after initiation of a tokenizing step.

The context window, or context length, of a large language model is the amount of text, in tokens, that the model can consider or “remember” at any one time. A larger context window allows an AI model to process longer inputs and incorporate a greater amount of information into each output. An LLM's context window can be thought of as the equivalent of its working memory. The context window determines how long of a conversation the LLM can carry out without forgetting details from earlier in the exchange. The context window also determines the maximum size of documents, code bases, or text that the LLM or API can process at once. When a prompt, conversation, document, or code base exceeds an artificial intelligence model's context window, the input must be truncated or summarized for the model to proceed. When truncating a body of text, as discussed herein, a chunk is created. A chunk may be a portion of a larger body of text that may fit within a context window of an LLM or API. Chunks may contain numbers, characters, English letters etc. Chunks may also be index-labeled before being sent to an API. Index-labeling may allow an “Ordered Dictionary” data structure to store each chunk as a value, with the corresponding keys mapped to the index number of the chunk. The creation and selection of these chunks represent one aspect in which the invention improves on current summarization techniques.

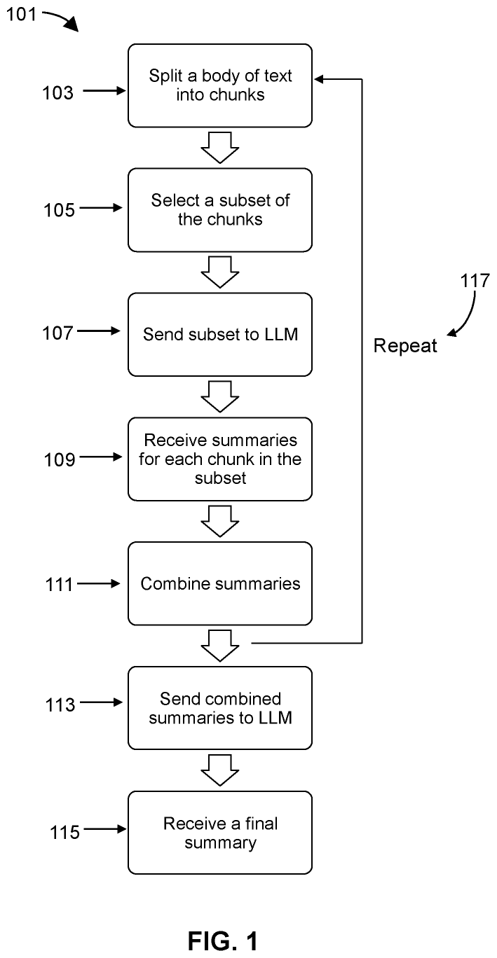

FIG. 1 shows a method 101 for summarizing text. The method 101 includes splitting 103 a body of text into chunks 402. A first subset of chunks may be then created by selecting 105, according to a set of rules, specific chunks from the initial set of chunks 402. This first subset, which may comprise only selected chunks 404, may then be sent 107 to an LLM along with a prompt instructing the LLM to summarize each chunk 404 in the subset. The summaries received 109 may be combined 111 into one. At this point, if the combined summaries fit within the context window of the LLM and API, then the combined summaries may be sent 113 back to the LLM with instructions to return a final summary. However, if the combined summaries exceed the context windows, then the method 101 may be repeated 117 as many times as needed, generating subsequent subsets, until a final summary is received 115.

The splitting 103 through combining 111 steps of the method 101 may be executed on a client system. In some embodiments, the recited steps may be executed by computer program instructions residing on a client computer operated by a user, where the prompt and the prompt for the summary of the second or subsequent subsets may be each independently entered by the user or pre-stored among the computer program instructions.

In certain embodiments, each subset contains chunks 402 that originally comprised the larger body of text.

In other embodiments, each chunk and the prompt may fit within a context window of the LLM or API, and the LLM may give a summary of that chunk within about 1 second of receiving that chunk. The chunks may also be index-labeled so that the chunks do not have to be returned from the LLM in order. The LLM may operate within an application-specific integrated circuit (ASIC) or AI accelerator on a remote system communicatively coupled to a client system executing the splitting 103 through combining 111 steps of the method 101. In some embodiments, the splitting 103 and combining 111 steps may be provided on a client computer system and the text may be sent to, and received from, a server system hosting the LLM via an application programming interface specific to the LLM.

In some embodiments, the LLM summarizes each chunk of the plurality of chunks in an independent process and executes multiple processes in parallel.

In further embodiments, the combining step 111 may include tokens or text from non-selected chunks. For example, a user may choose a number of tokens or an amount of text from non-selected chunks to combine with the selected chunks 404. This approach may improve the accuracy of the returned summaries from the LLM

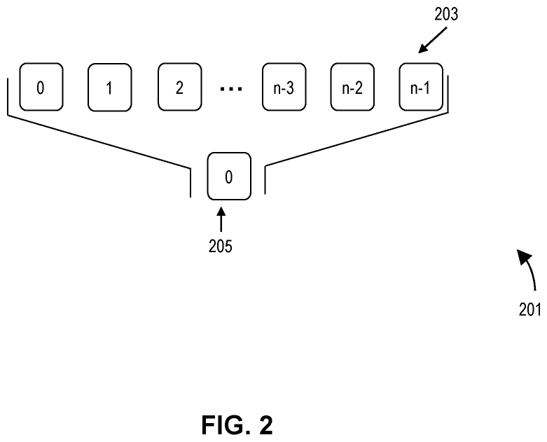

FIG. 2 shows a simplified method 201 to summarize a text that may be larger than a context window. After a text is broken into chunks, where each chunk may be smaller than the context window, the chunks may be sent to an LLM to be summarized. The LLM then returns a summary 203 of each chunk. The summaries of each chunk may then be combined to create a combined summary 205.

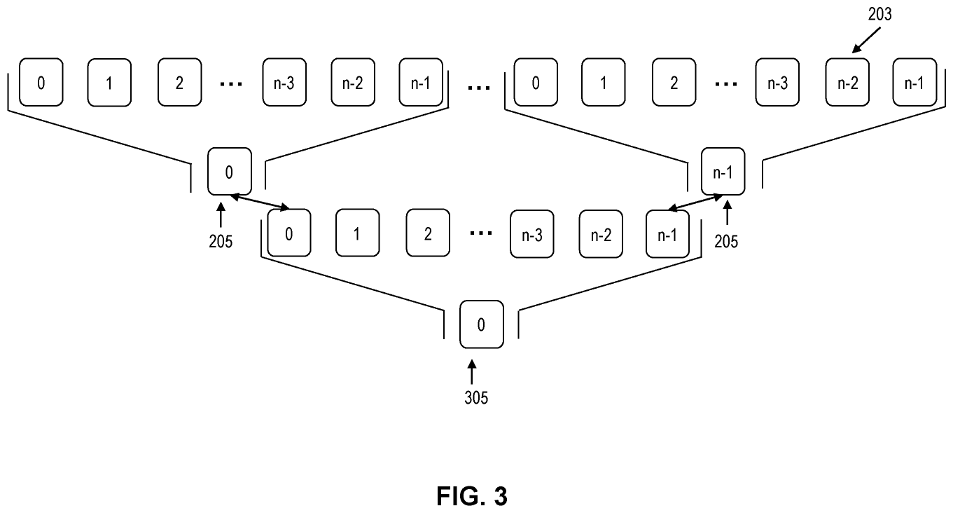

FIG. 3 shows the method 201 implemented in iterative tiers to generate more than one combined summary 205. Here, each combined summary 205 may be gathered and sent back to the LLM to produce a summary of the summaries, or a second-summary 305.

In some embodiments of an iterative method, a first subset and a second subset of chunks may comprise respective first and second tiers of an iterative summarization operation, where a set of rules may provide that, at each tier of the iterative summarization operation, a tier-specific number of chunks may be selected for summary. At any point, chunks that are not selected from a set of rules may be included in the subsets to send to the LLM. Including chunks not selected may increase the accuracy of the final summary. For example, if the iterative method generates three or more tiers of summaries, then at the tier before the final summary is generated, additional chunks not selected by the set of rules used for preceding tiers may be added to the chunks selected from the tier before the final summary. At some tiers, such as the first or second tiers, additional tokens (such as fifty or more tokens) or parts of a text that were not initially selected by the set of rules may also be included in a subset sent to the LLM, so that the subsets do not just include selected chunks. This method also may increase the accuracy of the final summary generated.

In other embodiments, at the first tier of the iterative summarization operation, a first batch of the plurality of chunks may be combined into a first batch summary and a second batch of the plurality of chunks may be combined into a second batch summary, so that the first set of summaries comprises the first batch summary and the second batch summary.

Other aspects of the invention include the LLM providing a first set of summaries, a second-summary subset, and a subsequent tier of summaries as part of a tiered operation defined by a set of rules. Here, the tiered operation may select a specific subset independently at each tier.

In some embodiments, some of which are described above, each chunk created from the initial splitting of the text may not be sent to the LLM. Instead, only a portion of the chunks may be selected to be sent to the LLM for summary. Thus, a first subset of the initial chunks may be generated, each with a summary provided by the LLM. The first subset may be chosen by using a set of rules. For example, the rules may specify different subsets or sizes of subsets at different stages of the method. The rules may also provide that, where a plurality of chunks comprises a number N, the first subset of the chunks will include a number f(N) of chunks, where f(N)=ln(N), root(N), or x*ln(N) where x is a range corresponding to the number of iterations such as {number of iterations-1 . . . 0}. In some embodiments, the set of rules may provide that the first subset of chunks comprises Log2 or the square root of a number of the chunks, and any chunks not selected for the first subset may not be presented to the LLM and thus will not inform the summary of the text.

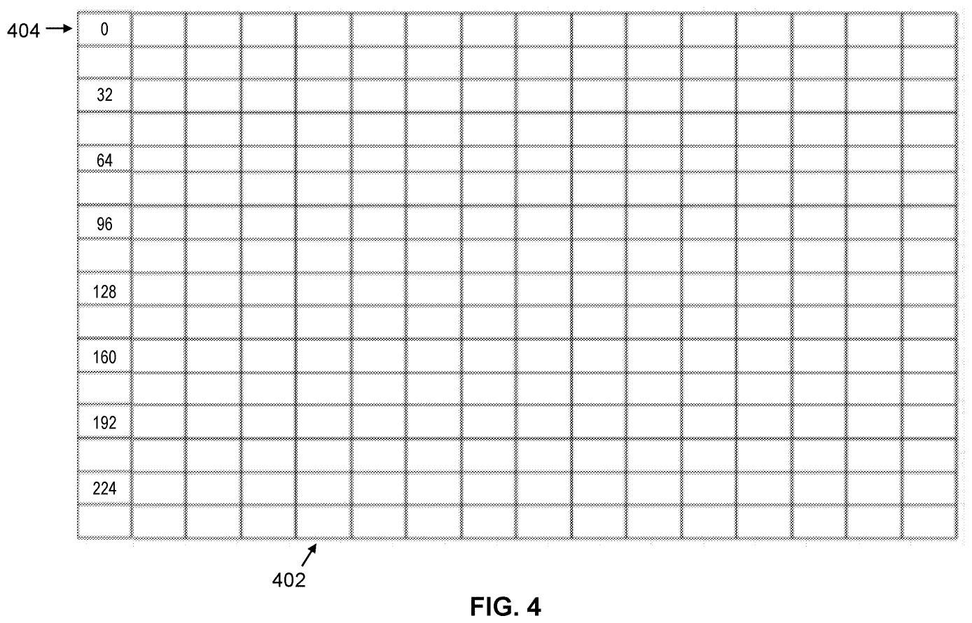

FIG. 4 illustrates how methods and systems of the invention may use log2 chunking to determine how many and which chunks 402 should be sent to the LLM for summary. Here, a body of text may be divided into 256 chunks 402. Calculating the log2 of 256 gives 8. Thus, 8 chunks 402 out of the 256 may be selected chunks 404 to send to the LLM to summarize. As illustrated, every 32^{nd} chunk, counting the very first one, may be selected.

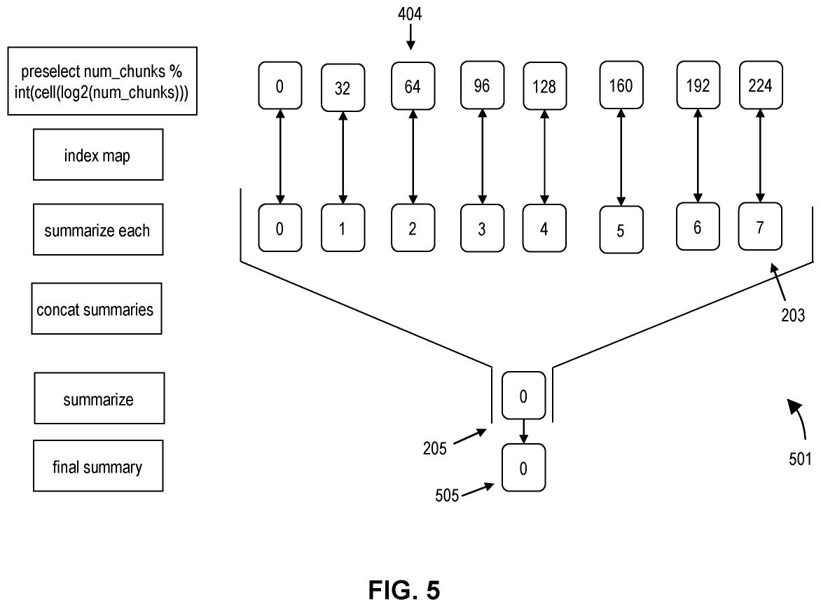

FIG. 5 shows how log2 selected chunks 404 may be used by systems and methods of the invention. Using the log2 chunking method 501 the selected chunks 404 may be index-labeled and then sent to an LLM with a prompt to summarize each selected chunk 404. The LLM then returns a summary 203 of each selected chunk 404. The returned summary 203 of each selected chunk 404 may be then combined to create a combined summary 205 before being sent back to the LLM to generate a final summary 505.

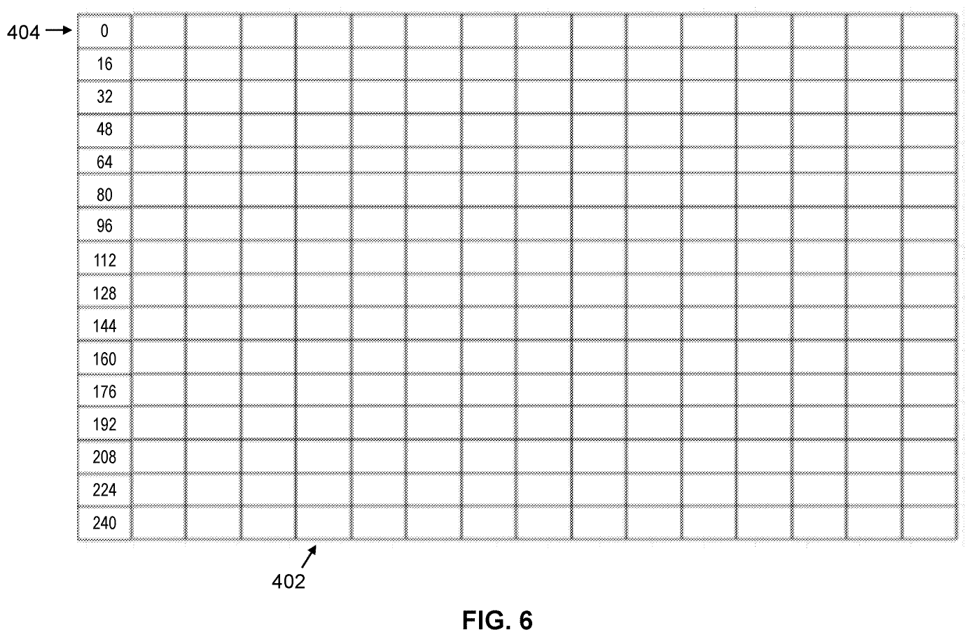

FIG. 6 illustrates how methods and systems of the invention may use square root chunking to determine how many and which chunks 402 should be sent to the LLM for summary. Here, a body of text may be again divided into 256 chunks 402. The square root of 256 is 16. Thus, 16 chunks 402 out of the 256 may be selected chunks 404 to send to the LLM to summarize. As illustrated, every 16^{th} chunk, counting the very first one, may be selected.

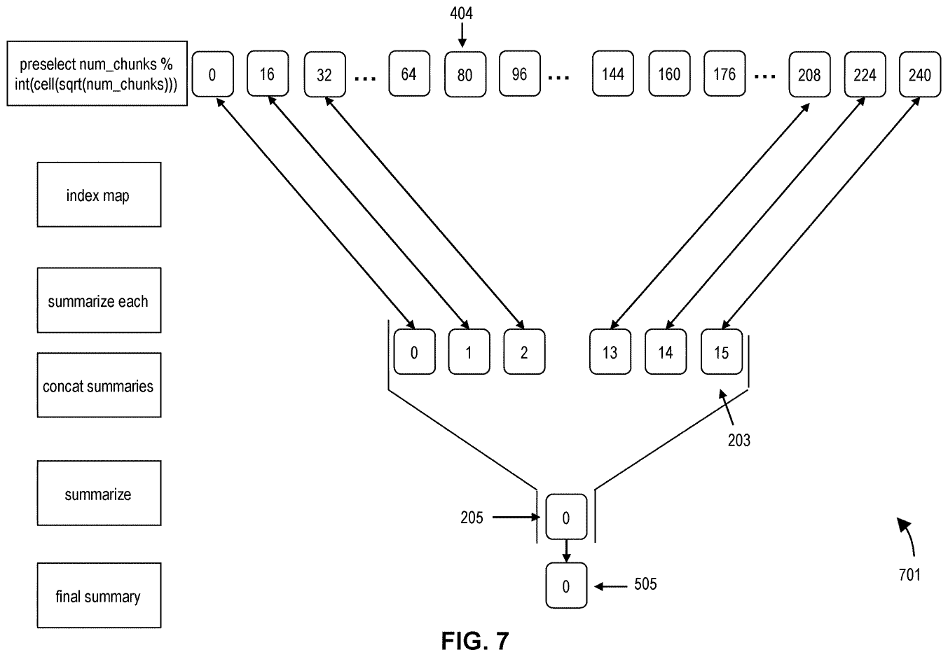

FIG. 7 shows how the square root selected chunks 404 may be used by systems and methods of the invention. Using the square root chunking method 701 the selected chunks 404 may be index-labeled and then sent to an LLM with a prompt to summarize each selected chunk 404. The LLM then returns a summary 203 of each selected chunk 404. The returned summary 203 of each selected chunk 404 may be then combined to create a combined summary 205 before being sent back to the LLM to generate a final summary 505.

Though the invention is not limited to the rule sets or algorithms disclosed, log2 chunking may be particularly useful in methods of the invention because it is a binary logarithm. In mathematics, the binary logarithm (log₂ n) is the power to which the number 2 must be raised to obtain the value n. So, if a problem initially has n choices for its solution, and each iteration of the algorithm reduces the number of choices by a factor of two, then the number of iterations needed to select a single choice is again the integral part of log₂ n. In other words, determining the log2 of a number of chunks will inform a user on how many times the number of chunks must be halved to end with just 1 chunk. This may be useful in certain embodiments of the invention to produce a final summary.

The invention also provides methods for precise tokenization which may increase the accuracy of text sent to the LLM and the returned summaries. Here, an entire text may be tokenized at the first step and then chunks may be created by token count based on the limits of the LLM and API (e.g. exactly 8912 tokens per chunk). The token chunks may then be converted back to text and then sent to the LLM for summary. This approach may increase accuracy because the approximations that come with character and word-level chunking may be avoided and the chunks that may be sent to the LLM may be more likely to be within the LLM and API token limitations. Additionally, the method reduces the risk of truncated inputs, unintended splits in the text, or off-by-one token errors.

Other methods of the invention use the precise tokenization described previously but may skip the step that converts the intermediate tokenized chunks back to text. Instead, the tokenized chunks may be sent directly to the LLM where tokenized summaries may be returned. The tokenized summaries may then be combined, chunked, and sent to the LLM once more. The process may be repeated until a single tokenized summary is returned from the LLM, which may be then converted back to text. Here, the text may remain tokenized throughout the summarization process, and then may be converted back to text at the very end.

In certain embodiments of the invention, the splitting step may split the text based on chapter breaks, section headers, pages, groups of pages, or other markers within the text. Each split part or chunk may be tokenized at the same time by parallel processing. The chunks for a first subset may then be selected based at least in part on being near or including a beginning of a section or chapter of the text. The chunks may be prepared using a retrieval augmented generation (RAG) operation. RAG is a technique that allows generative artificial intelligence (Gen AI) models to retrieve and incorporate new information. RAG modifies interactions with a large language model (LLM) so that the model responds to user queries with reference to a specified set of documents, using this information to supplement information from its pre-existing training data. This allows LLMs to use domain-specific and/or updated information.

In other embodiments, an operation may be performed to replace one or more pronouns in the text with antecedents. A delimiter may also be used in the prompt to the LLM to include some lines or parts of a non-selected chunk in a selected chunk so that information, such as what a pronoun is referring to, is not lost.

### EXAMPLES

### Example 1: Summarizing Legislative Text

One application for systems and methods herein is summarizing legislative bills. For example, a user may have access to a computer, phone, tablet, or any kind of client system that may be capable of connecting to and communicating with an LLM through an associated API. The user may take a legislative text, such as a bill that is being debated in a congress that may be several thousand pages long, and input the legislative text into the systems described herein along with a prompt to instruct the LLM to summarize the text. The system may first tokenize the text before splitting the tokenized text into several chunks. The number of chunks may be determined by taking the smaller of the context windows of the API and LLM and then subtracting a number of tokens to account for the summary that will be generated by the LLM and the prompt instructing the LLM to generate the summary. The number of tokens in the text may be then divided by that subtracted number to determine how many chunks may be needed to account for the entire text. The square root of the resulting number may then be taken to determine how many chunks may make up a first subset of the chunks.

For example, if a context window is 16,384 tokens, then, accounting for about 918 tokens for the returned summary, prompt, and other background processes or parameters that require tokens, the number of tokens that can be taken from the text equals 15,430 tokens per chunk. If the document is 3.95 million tokens long, then, when divided by 15,430 and then rounded up, it is determined that 256 chunks will have to be generated. From these 256 chunks, a rule or algorithm may be applied to determine how many and which chunks will be sent to the LLM. If the square root is used, then 16 chunks will be selected to form a first subset. This first subset of chunks may be sent to the LLM with prompts accompanying each chunk instructing the LLM to generate a summary of that chunk. The return may be a first set of summaries based on the first subset of chunks. This first set of summaries may then be combined and sent back to the LLM for a final summary. Or, if the combined summaries exceed the context window, then methods of the invention may be repeated, creating subsequent subsets and summaries using the same rules for previous subsets, until the combined summaries can be sent to the LLM without the need to be chunked to return a final summary. This final summary may be generated within seconds of the client making the request.

### Example 2: Financial Markets

In another example, methods of the invention may be used for summarizing text related to financial markets, publicly traded companies, stocks, or other similar sources of data. For example, there are subscription services that deliver nonstop high-volume news and data of publicly traded companies organized by ticker symbol or stock symbol. That high volume of news and data is a body comprising text that can be read by a system of the invention, which involves splitting the body comprising text into a plurality of chunks, selecting, according to a set of rules, a first subset of the chunks and inputting each chunk of the first subset into a large-language model (LLM) with a prompt for the LLM to give a summary of that chunk. The summaries received from the LLM may be chunked and selected to create a second subset using the same set of rules used to create the first subset. The LLM may be once again prompted to summarize each chunk to create a second-summary subset. The process may be repeated until the LLM returns a final summary.

### Example 3: Patent Databases

Another example includes summarizing the histories of filings, trends, and technology found within a patent database. Here, the text found within applications that describe the technology, or the text contained in documents throughout prosecution of an application may be compiled and split into chunks. The chunks may be split into a first subset of selected chunks by a set of rules before sending the chunks in that subset, and optionally around at least 50 extra tokens from non-selected chunks, to an LLM with a prompt to generate summaries for each chunk. The summaries returned by the LLM may then be combined and chunked again by the same set of rules, once again including about 50 or more tokens from non-selected chunks to send to the LLM for another summary of the chunks. The process may repeat, but by the penultimate tier of summaries, instead of including tokens from non-selected chunks, whole chunks that may not be selected by the set of rules may be sent to the LLM in addition to the selected chunks. Thus, the final summary will be generated from chunks selected by the set of rules and some chunks that were not selected by the rules.

What is claimed is:

1. A method for summarizing text, the method comprising:
splitting a body comprising text into a plurality of chunks;
selecting, according to a set of rules, a first subset of the chunks and inputting each chunk of the first subset into a large-language model (LLM) with a prompt for the LLM to give a summary of that chunk;
receiving a first set of summaries from the LLM including one summary for each chunk of the first subset;
sending a second subset, selected according to the set of rules from the first set of summaries, to the LLM with a prompt for a summary of the second subset and receiving a second-summary subset from the LLM;
providing the second-summary subset as a penultimate set of summaries or sending additional subsets selected by the set of rules to the LLM to receive a subsequent tier of summaries and providing the subsequent tier of summaries as the penultimate set of summaries; and
combining the penultimate set of summaries into a summary of the text.

2. The method of claim 1, wherein the set of rules specifies different subsets or sizes of subsets at different stages of the method.

3. The method of claim 1, wherein the plurality of chunks comprises a number N of chunks, and wherein the set of rules provides that the first subset of the chunks will include a number f(N) of chunks, wherein f(N)=ln(N) or root(N).

4. The method of claim 1, wherein the first subset and the second subset comprise respective first and second tiers of an iterative summarization operation, wherein the set of rules provides that, at each tier of the iterative summarization operation, a tier-specific number of chunks is selected for summary.

5. The method of claim 4, wherein at the first tier of the iterative summarization operation, a first batch of the plurality of chunks are combined into a first batch summary and a second batch of the plurality of chunks are combined into a second batch summary, wherein the first set of summaries comprises the first batch summary and the second batch summary.

6. The method of claim 1, wherein the splitting step provides that one chunk of the plurality of chunks plus the prompt fits within a context window of the LLM.

7. The method of claim 1, wherein the LLM summarizes each chunk of the plurality of chunks in an independent process and executes multiple processes in parallel.

8. The method of claim 1, further comprising tokenizing the text whereby each chunk of the plurality of chunks comprises a number of tokens.

9. The method of claim 8, wherein when the body of text comprise at least 32,000 pages of English language writing and when the number of tokens is greater than 3 million, the summary of the text is provided in under 1 minute after initiation of a tokenizing step.

10. The method of claim 1, wherein the splitting and combining steps are provided on a client computer system and wherein the text is sent to, and received from, a server system hosting the LLM via an application programming interface (API) specific to the LLM.

11. The method of claim 1, wherein the set of rules provides that the first subset of chunks comprises Log2 or square root of a number of the plurality of chunks and wherein ones of the plurality of chunks that are not included in the first subset are not presented to the LLM and do not inform the summary of the text.

12. The method of claim 1, wherein the LLM provides the first set of summaries, the second-summary subset, and the subsequent tier of summaries as part of a tiered operation defined by the set of rules, wherein the tiered operation selects a specific subset independently at each tier.

13. The method of claim 1, wherein the body of text comprises one selected from the group consisting of: a collection of documents from a legal proceeding; a bill drafted by a legislature; a corpus of literary work; a corpus of research and/or publications relating to one company or stock trading symbol; the results of a document production request; a corpus of text comprising multiple gigabytes of text; and a set of material returned by a search of a database or the Internet.

14. The method of claim 1, wherein each chunk and the prompt fit within a context window of the LLM, wherein the LLM gives the summary of that chunk within about 1 second of receiving that chunk, and wherein the LLM operates within an AI accelerator on a remote system communicatively coupled to a client system executing the splitting through combining steps of the method, wherein the client system comprises a laptop or desktop computer.

15. The method of claim 1, wherein the recited steps are executed by computer program instructions residing on a client computer being used by a user, wherein the prompt and the prompt for the summary of the second subset are each independently entered by the user or pre-stored among the computer program instructions.

16. The method of claim 1, wherein:
the splitting step splits the text based on chapter breaks, section headers, or other markers within the text;
the chunks for the first subset are selected based at least in part on being near or including a beginning of a section or chapter of the text;
the chunks are prepared using a retrieval augmented generation (RAG) operation; and/or an operation is performed to replace one or more pronouns in the text with antecedents.

17. A system for summarizing text, the system comprising:
a processor coupled to a memory having instructions stored therein executable by the processor to cause the system to:
split a body comprising text into a plurality of chunks;
select, according to a set of rules, a first subset of the chunks and input each chunk of the first subset into a large-language model (LLM) with a prompt for the LLM to give a summary of that chunk;
receive a first set of summaries from the LLM including one summary for each chunk of the first subset;
send a second subset, selected according to the set of rules from the first set of summaries, to the LLM with a prompt for a summary of the second subset and receiving a second-summary subset from the LLM;
provide the second-summary subset as a penultimate set of summaries or sending additional subsets selected by the set of rules to the LLM to receive a subsequent tier of summaries and providing the subsequent tier of summaries as the penultimate set of summaries; and
combine the penultimate set of summaries into a summary of the text.

18. The system of claim 17, wherein the set of rules specifies different subsets or sizes of subsets at different stages.

19. The system of claim 17, wherein the plurality of chunks comprises a number N of chunks, and wherein the set of rules provides that the first subset of the chunks will include a number f(N) of chunks, wherein f(N)=ln(N) or root(N).

20. The system of claim 17, wherein the first subset and the second subset comprise respective first and second tiers of an iterative summarization operation, wherein the set of rules provides that, at each tier of the iterative summarization operation, a tier-specific number of chunks is selected for summary.
